(19) United States
(12) Patent Application Publication
(10) Pub. No.: US 2009/0035459 A1
(43) Pub. Date: Feb. 5, 2009

(54) COATED PIPE AND METHOD USING STRAIN-HARDENING BRITTLE MATRIX COMPOSITES

(76) Inventors: Victor C. Li, Ann Arbor, MI (US); Michael Lepech, Ann Arbor, MI (US); Weiping Liu, Guangzhou (CN); Weichong Du, Burnaby (CA)

Correspondence Address: GIFFORD, KRASS, SPRINKLE,ANDERSON & CITKOWSKI, P.C, PO BOX 7021, TROY, MI, 48007-7021, US

(21) Appl. No.: 11/833,746

(22) Filed: Aug. 3, 2007

(51) Int. Cl. B05D 1/36

(52) U.S. Cl. 427/202

(57) ABSTRACT

Pipe cladding is based upon a fiber-reinforced brittle matrix composite material. The coating is isotropic, demonstrating pseudo-strain hardening behavior in uniaxial tension, and damage tolerance by design, not relying on stratified layers of reinforcing mesh embedded within concrete or other brittle cementitious matrices for impact resistance, fracture toughness, or crack width control. The fiber reinforced brittle matrix composite cladding protects both the pipe and inner thin, anti-corrosion layer (if present) from impact or abrasion damage while permitting bending of coated and clad pipe. The finished composite clad can be in a simple circular form alone the pipe or in some complex form providing an integrated housing for electrical or optical fiber cables, or optical sensing sensors for continuous or intermittent sensing of pipeline leakage or failure.

### FIELD OF THE INVENTION

This invention relates generally to pipeline protection and, more particularly, to the use of fiber-reinforced brittle matrix inorganic composites in such applications.

### BACKGROUND OF THE INVENTION

Metal pipes used in pipeline applications are typically coated with a layer of corrosion-resistant material, often a thin resinous layer, which serves as a barrier to penetration of water and other corrosives thereby protecting the base metal from corrosion damage. While in practice cathodic protection of the metal pipe may also be employed, this thin resinous layer is critically important to maintaining the integrity of the pipeline after installation.

During the transportation and installation process, both the pipe and the anti-corrosion layer are susceptible to mechanical damage, impact, and abrasion caused by falling rock and debris during backfilling operations. To prevent this potentially disastrous damage, a protective jacket is required to protect both the metal pipeline and thin resinous layer from impact or abrasion.

Current construction practice for protection of pipeline coatings provides for initial placement of the pipe into a bed of sand in a constructed trench. The pipeline segments are carefully laid into the trench and delicately covered with sand material over their entire length. The fine particle size of this sand prevents impact, penetration, and abrasion loads from rocks and other overburden that may cause damage to the thin resinous anti-corrosion layer. Once backfilled with sand to a level higher than the pipeline crown, local backfill materials are used to restore the site. Trucking of vast quantities of sand for embedment of pipelines is prohibitively costly and time consuming.

However, a major obstacle to providing an effective structural protective coating around the thin resinous anti-corrosion layer is the seemingly contradictory requirements of high impact, penetration, and abrasion resistance while providing sufficient flexibility to accommodate bending of the coated metal pipe up to a specified amount, typically 1.5° of permanent deflection per pipe diameter.

An example of such a coating that can be applied to a metal pipe for pipeline applications is described in U.S. Pat. Nos. 4,611,635 and 4,759,390. These cladding structures are dependent upon a stratified layering of brittle matrix material surrounding the coated pipe, covered with reinforcing mesh for tensile strength, toughness, impact resistance, and cracking control, and surrounded with additional brittle matrix material to protect the reinforcement and provide further impact resistance. A polymer outer wrapping is then added. This complex layered protective cladding is difficult to manufacture, as noted by U.S. Pat. Nos. 4,544,426 and 4,785,854.

Concrete-coated metal pipes have been used previously in primarily offshore applications where the weight of concrete coatings is needed to permanently submerge pipeline installations. Canadian Patent Nos. 959,744 and 1,076,343 specifically relate to this application. Due to the high rigidity of these claddings however, their application to terrestrial applications is limited with respect to accommodation of pipeline bending as it is constructed.

Inherent within providing pipeline protection against failure during initial construction, pipeline operators need routine maintenance and capacity for sensing accidental impacts or loadings and thereby monitoring of the pipeline systems for leaks or failures. For this reason, some sensing cables (either electrical cable or optical fiber cable or distributed optical fiber sensors) are laid or attached along the pipelines for realizing such monitoring functions. Installation of the cables along pipelines is difficult and highly time-consuming, and some additional protection measures to the cables are required during the construction period.

### SUMMARY OF THE INVENTION

The present invention improves upon prior-art pipe protection methods by providing a cladding material, which is damage tolerant by design, without reliance upon the structural configuration of the cladding to accommodate limited bending of the pipe.

This is accomplished with an isotropic cladding material that can be applied or extruded in a continuous fashion without regard to specific structural configuration, layering, or stratification requirements. As pipe diameters become exceedingly large or small, existing pipe claddings that rely on structural geometry or stratification can be difficult to manufacture. However, in contrast to existing materials, the invention material may be applied without regard to pipe diameter. The material may be applied to any type of pipe to be protected, including metal pipelines, plastic/polymeric and glass/ceramic, with thicknesses in the range of 5 mm or less to 100 mm or more.

The invention is suitable for fabrication of concrete weight coating around pipe for off-shore applications. This can be done while eliminating structural mesh reinforcement through dispersed fiber reinforcement and reducing the product cost significantly by uniformly doping the reinforced fiber cladding with heavyweight fillers, such as metal powders, etc.

According to one aspect of the invention there is provided a pipe of any size diameter, which is then coated with an impact, and abrasion resistant cladding material that is isotropic and inherently damage tolerant by nature. The cladding material does not rely on stratified layers of reinforcing mesh embedded within concrete or other brittle cementitious matrices for impact resistance, fracture toughness, or crack width control.

In the preferred embodiments, the cladding material is based upon a fiber-reinforced matrix, cementitious in nature for certain applications, which demonstrates pseudo-strain-hardening behavior in uniaxial tension with random orientation of fibers within the composite to provide impact and abrasion resistance. This cladding material possesses which tensile ductility to allow bending of the coated pipe without causing large cracks or disintegration through cladding material fracturing.

For cases in which the piping material is non-corroding, such as plastic, organic, or other material, the anti-corrosion polymeric layer barrier may be eliminated and only the abrasion resistance, damage tolerant cladding be used to clad the pipe. The pipe may be metal pipe for use in pipeline applications, in which case a protective anti-corrosion layer barrier may be bonded to the external pipe surface. This coating may be a polymeric coating impermeable to water.

The protective cladding layer may be of any thickness, and of any density provided that the material is isotropic and inherently damage tolerant. However, thinner cladding configurations of lightweight material are preferred to facilitate shipping, construction, maintenance, and disposal of the pipeline sections, and to reduce material volume and cost. In some applications the cladding may be configured as heavyweight material to facilitate offshore applications. In this case, heavyweight fillers (i.e. non-reactive in nature) may be used to increase the density of the heavyweight, pseudo-strain-hardening, and fiber reinforced matrix. The material may be formulated for lightweight applications, with densities even below that of water (typically 1,000 kg/m³), while heavyweight versions of the cladding material range from 2200 kg/m³ (the density of common concrete) or less up to 4000 kg/m³ or more.

According to another aspect of the present invention, there is provided a structural configuration integrated within the impact-resistant cladding for protective housing of in-line leakage and failure monitoring technology. The present invention relies on optical sensing technology integrated into the pipe system for continuous or intermittent sensing of pipeline leakage or failure. According to the invention, a side path can be easily fabricated upon the top of the protective coating (or cladding) for housing the sensing cable along the pipe. With this pre-built side path along the pipeline, sensing cable can be installed quickly and protected effectively, and easily accessed later on for maintaining services.

### BRIEF DESCRIPTION OF THE DRAWINGS

FIG. 1 illustrates a stress strain curve for one embodiment of a pseudo-strain-hardening brittle matrix composite used in the present invention;

FIG. 2A illustrates an application of the invention to a pipe of any size diameter;

FIG. 2B illustrates a pipe without the protective housing integrated within the cladding structure to facilitate installation of optical-based sensing equipment to detect leakage or failure along the pipe structure;

FIG. 2C illustrates a pipe manufactured with an open housing integrated within the cladding structure to facilitate installation of optical-based sensing equipment to detect leakage or failure along the pipe structure

FIG. 3A illustrates an early stage manufacturing step;

FIG. 3B illustrates a late stage manufacturing step;

FIG. 4A is a perspective view of a second equipment setup manufacturing process adapting a doubly hinged, three-part circular formwork that is clamped around the embedded pipe

FIG. 4B shows the hinged formwork closed;

FIG. 5 is a perspective view of a second equipment setup manufacturing process;

FIG. 6 is a perspective view of a second equipment setup manufacturing process;

FIG. 7 is a perspective view of the fabrication of a casting sleeve;

FIG. 7B is a perspective view of a second equipment setup manufacturing process;

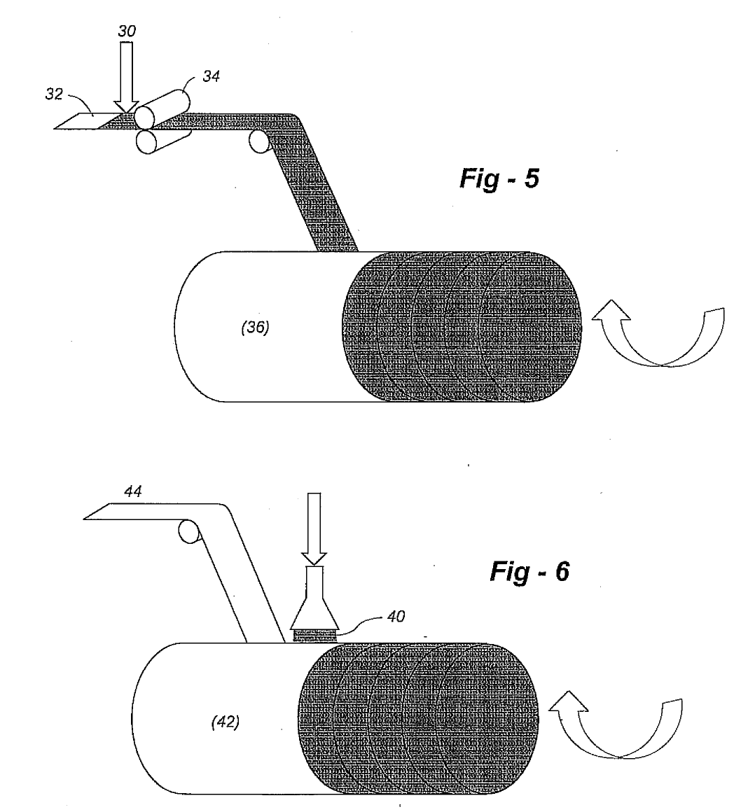

FIG. 5A is yet a further manufacturing technique;

FIG. 8B shows fiber reinforced brittle matrix composite material is directly applied to the pipe surface; and

FIG. 9 shows a different, alternative manufacturing process, which involves the use of a movable casting sleeve that is filled with said fiber, reinforced brittle matrix composite material.

### DETAILED DESCRIPTION OF THE INVENTION

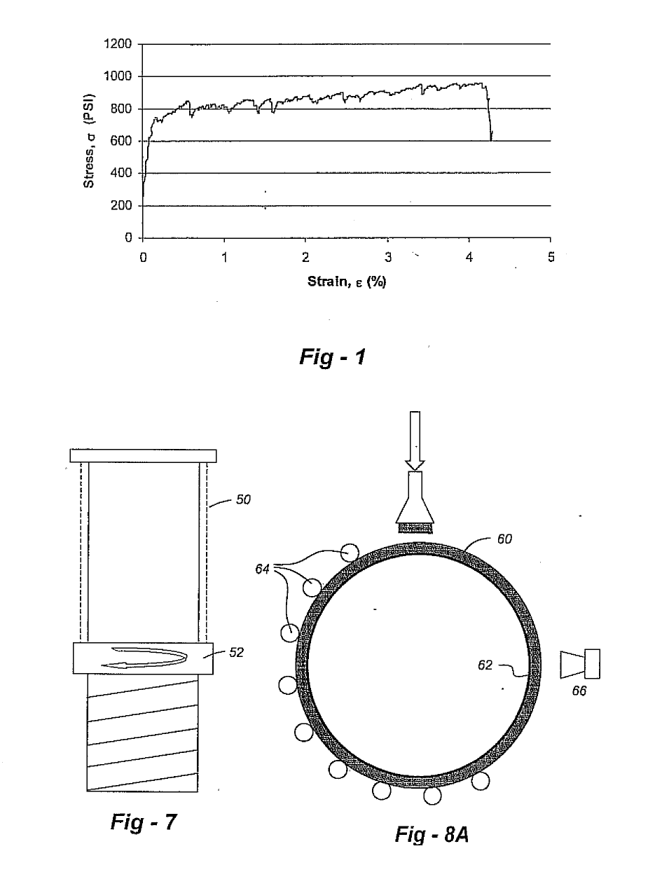

Referring to FIG. 1, the preferred embodiment of the invention uses a fiber reinforced matrix as a pipeline cladding material. This material, which is cementitious in nature for certain applications, exhibits pseudo-strain-hardening properties when loaded in uniaxial tension. Details of the material itself may be found in Li, V. C., “On Engineered Cementitious Composites (ECC)—A Review of the Material and its Applications,” J. Advanced Concrete Technology, Vol. 1, No. 3, pp. 215-230, 2003, the entire content of which is incorporated herein by reference. The pseudo-strain-hardening behavior of the preferred material is marked by forming a distribution of tightly spaced microcracks in the strain-hardening deformation range to accommodate macroscopic tensile, bending, or shear deformation without forming large localized cracks in excess of 200 μm in width.

When cementitious in nature, fiber reinforced brittle matrix composites may be formed of a mixture of cementitious materials, inert fillers, reinforcing fibers, water, and processing chemical additives. The term “cementitious” includes conventional cements and mixtures thereof, and other building compositions that rely on hydraulic curing mechanisms. Examples of such materials include, but are not limited to, lime cement, Portland cement, refractory cement, slag cement, expansive cement, pozzolanic cements, industrial slags, industrial fly ash, mixtures of cements, etc. The term “inert fillers” includes, but is not limited to, natural sands, metal or other powders (for concrete weight coating), industrial wastes, processed aggregates, etc. The term “fibers” includes, but is not limited to, metallic fibers, polymeric fibers, inorganic fibers, and natural fibers, etc. any of which are used for structural reinforcement or fracture suppression within the brittle matrix. The term “processing chemical additives” includes, but is not limited to, stabilizing admixtures, derivatized celluloses, and superplasticizers.

A specific example of a useful composition for this fiber reinforced brittle matrix composite, expressed as a weight ratio, unless otherwise indicated, is as follows:

| Cement¹ | Sand² | Fly Ash³ | Water | HRWR⁴ | Fiber (vol %)⁵ |
|---|---|---|---|---|---|
| 1 | 0.8 | 1.2 | 054 | 0.013 | 2.0 |

¹Ordinary Portland Cement Type I (average particle diameter size = 11.7 ± 6.8 μm, LaFarge, Co.
²Silica Sand (average particle diameter = 110 ± 6.8 μm, U.S. Silica Corp.)
³Fly Ash (average particle diameter = 2.4 ± 1.6 μm, Boral Material Technologies, Inc.)
⁴High Range Water Reducer (Polycarboxylate-based superplasticizer, W.R. Grace Chemical Co.)
⁵Poly-vinyl-alcohol fibers (average length = 6-8 mm, average diameter = 39 μm ± 6 μm, Kuraray Company, Ltd.)

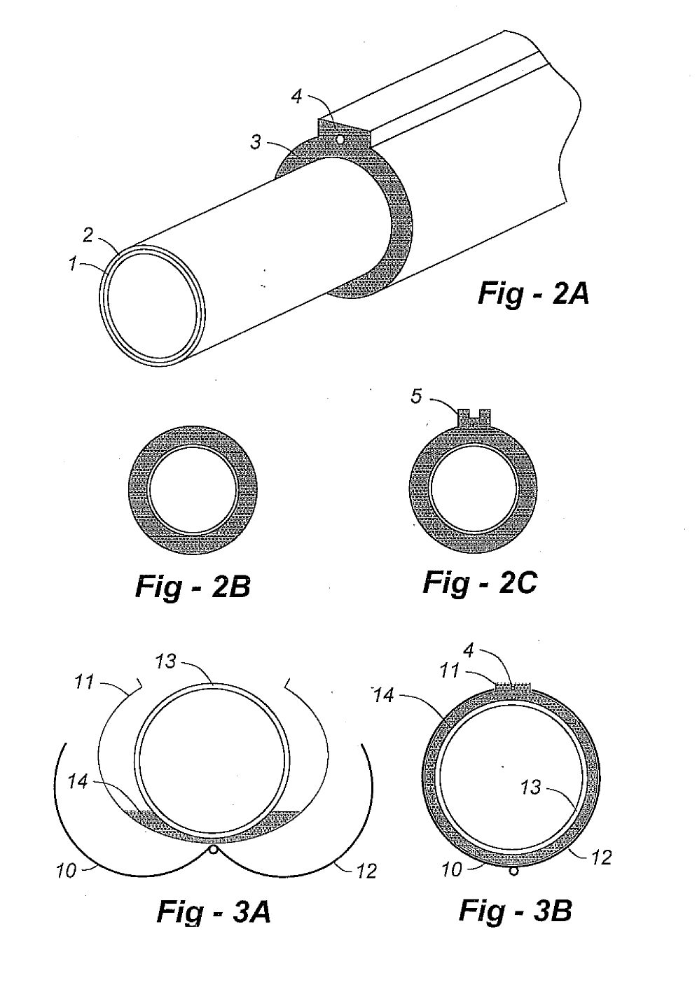

FIG. 2A illustrates an application of the invention to a pipe 1 of any size diameter intended for use in a pipeline application. In the case of pipe materials, which corrode, such as metal, the pipe may be coated externally with a first water-impermeable polymeric layer 2 for protection against corrosion. This first anti-corrosion layer may be made of any anti-corrosive polymeric layer which bonds easily to a metal substrate and provides a long-lasting, water-impermeable barrier surrounding the external surface of the metal pipe. In the present preferable example, a first layer of epoxy resin may be used.

The anti-corrosion coated pipe is encased within a second layer of pseudo-strain-hardening composite 3 which is isotropic and inherently damage tolerant by nature, not requiring external or embedded reinforcement in the form of rebar, mesh, large strands, or continuous fabrics. The composite may have a thickness in the range of 5 mm or less to 50 mm or more in thickness to provide the necessary level of impact resistance and damage protection to both the metal pipe and anti-corrosion layer. The anti-impact cladding is not intended to be truly water-impermeable so as not to prohibit cathodic protection of the metal pipe.

Along the length of the pipe, a completely enclosed protective housing 4 is optionally integrated within the cladding structure to facilitate installation of optical-based sensing equipment to detect leakage or failure along the pipe structure. Referring to FIG. 2B, the present invention may also be manufactured without the protective housing integrated within the cladding structure to facilitate installation of optical-based sensing equipment to detect leakage or failure along the pipe structure. Referring to FIG. 2C, the present invention may also be manufactured with an open housing 5 integrated within the cladding structure to facilitate installation of optical-based sensing equipment to detect leakage or failure along the pipe structure.

The preferred embodiment, however, includes a pipe 1 of any size diameter with a two-layer protective coating of external anti-corrosion polymers 2 (in the case of corroding pipe material) and an impact and damage resistant cladding 4 composed of pseudo-strain-hardening composite material. Optical sensing technologies are integrated along the length of the pipe within a specifically constructed housing 4.

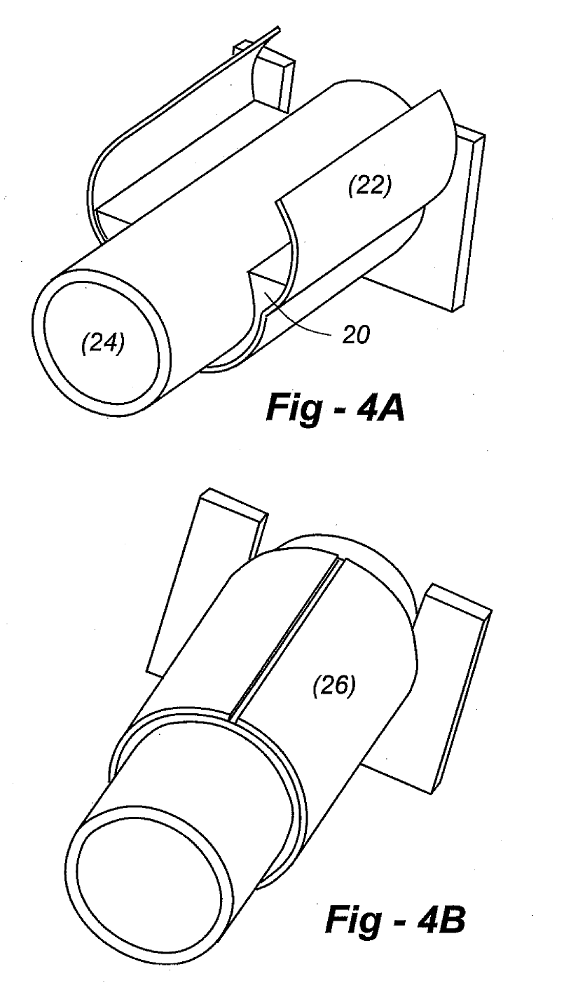

Referring to FIG. 3A, the present invention may be manufactured by adapting a singularly hinged, two-part circular formwork 10, 12 which can be clamped around the embedded pipe 13 (with anti-corrosion coating already applied if necessary). The fiber reinforced brittle matrix composite material 14 is in the fresh (not hardened) state. Optionally, a thin jacket of metal or other material 11 may be used to facilitate proper curing or hydration of the composite if needed to attain proper pseudo-strain-hardening behavior of the cladding material. Referring to FIG. 3B, once the hinged formwork 10, 12 is closed, the complete cladding system, including the integrated optical sensor housing 4 is formed. This housing 4 may be, but is not limited to, a thin plastic sheath embedded within the cladding that allows for external access for installation or maintenance needs.

Referring to FIG. 4A, the present invention may be manufactured by adapting a doubly hinged, three-part circular formwork 22 that is clamped around the embedded pipe 24 (with anti-corrosion coating already applied if necessary) The fiber reinforced brittle matrix composite material 20 is in the fresh (not hardened) state. Referring to FIG. 4B, once the hinged formwork is closed, the complete cladding system is formed at 26.

Referring to FIG. 5, the present invention may also be manufactured through the deposition of a thin layer of the fiber reinforced brittle matrix composite material 30 onto a thin film of plastic or other material 32. The thickness of the composite layer is regulated by a series of rollers 34 to ensure the proper cladding thickness. This ribbon of thin film and composite material is then wrapped around the pipe 36 (with anti-corrosion coating already applied, if necessary) as the pipe is slowly rotated about its longitudinal axis. Following proper curing or hydration of the cladding material, the thin film may be removed for installation of the integrated optical sensor housing which may be installed along the length of the pipe using adhesives or mechanical fasteners.

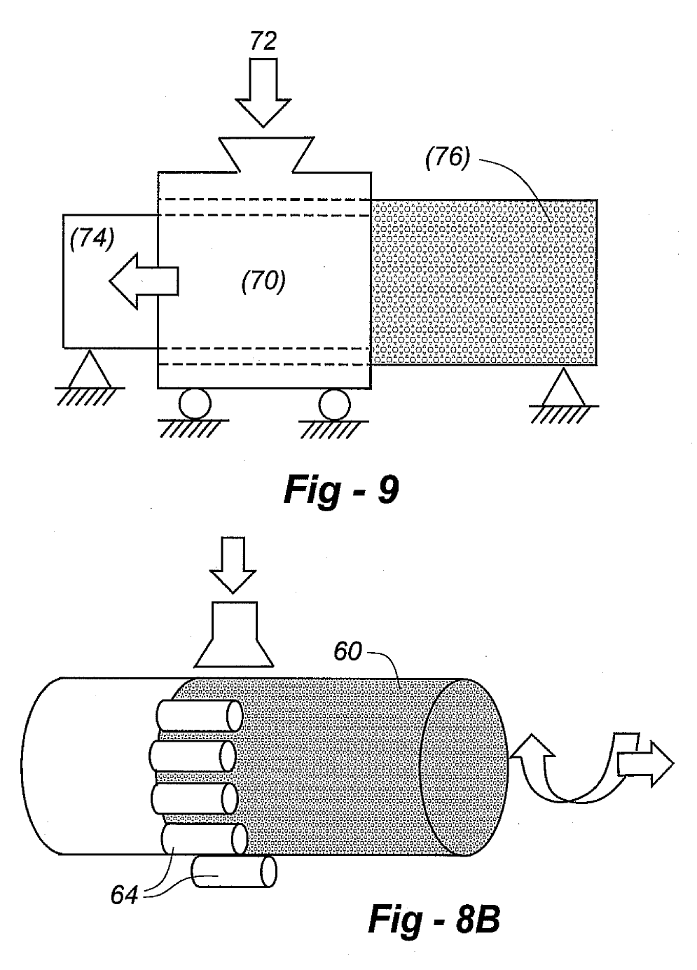

Referring to FIG. 6, the present invention may additionally be manufactured by the deposition of a precise, thin layer of the fiber reinforced brittle matrix composite material 40 directly onto the pipe 42 (with anti-corrosion coating already applied if necessary) by means of spraying, casting, or extrusion. To facilitate proper curing or hydration, a thin film of plastic or other material 44 is then wrapped around the exterior of the cladding while the pipe is rotated about its longitudinal axis. Following proper curing or hydration of the cladding material, the thin film may be removed for installation of the integrated optical sensor housing which may be installed along the length of the pipe using adhesives or mechanical fasteners.

Referring to FIG. 7, the present invention may alternatively be manufactured through the fabrication of a casting sleeve 50 which deposits a precise thin layer of the fiber reinforced brittle matrix composite material through spraying, extrusion, or casting while rotating around the pipe 52 (with anti-corrosion coating already applied if necessary). Within this casting sleeve, a thin layer of plastic or other material is applied to the external surface of the cladding to facilitate proper curing or hydration. Following proper curing or hydration of the said cladding material, the thin film may be removed for installation of the integrated optical sensor housing which may be installed along the length of the pipe using adhesives or mechanical fasteners.

FIG. 5A illustrates yet a further manufacturing technique. A thin layer of the fiber reinforced brittle matrix composite material 60 is applied directly onto the pipe 62 (with anti-corrosion coating already applied if necessary) by means of spraying, casting, or extrusion. The surface finishing and thickness adjustment of the composite cladding layer is maintained by a set of rollers 64 surrounding the circumference of the clad pipe. The thickness and quality of the cladding is preferably monitored using a camera 66. Referring to FIG. 5B, as the fiber reinforced brittle matrix composite material is directly applied to the pipe surface 1, the pipe is both drawn along and rotated about is longitudinal axis 2 to facilitate continuous fabrication.

FIG. 9 depicts a different, alternative manufacturing process, which involves the use of a movable casting sleeve 70 that is filled with said fiber, reinforced brittle matrix composite material 72. The pipe 74 (with anti-corrosion coating already applied if necessary) is held stationary as the casting sleeve moves along the length of the pipe. Extruded from this casting sleeve is the fiber reinforced brittle matrix composite material 76. An integrated housing for optical sensors may be created through the extrusion process or installed along the length of the pipe using adhesives or mechanical fasteners.

What is claimed is:

1. A method of protecting a pipe having an outer surface, comprising:
coating the outer surface of the pipe with a fiber-reinforced brittle matrix composite material of the type that exhibits pseudo-strain-hardening behavior in uniaxial tension by developing a series of microcracks rather than localized fractures to accommodate deformation of the pipe, at least to a specified amount.

2. The method of claim 1, wherein:
the pipe is metal; and
the outer surface of the pipe includes a previously applied anti-corrosion layer.

3. The method of claim 1, wherein the pipe is polymeric.

4. The method of claim 1, wherein the pipe is ceramic.

5. The method of claim 1, wherein the composite material is cementitious in nature.

6. The method of claim 1, wherein the composite material has a thickness in the range of 5 to 100 mm.

7. The method of claim 1, wherein the composite material does not contain external or embedded reinforcement in the form of mesh, strands, or fabrics.

8. The method of claim 1, wherein the specified amount of deformation is 1.5° of permanent deflection per pipe diameter.

9. The method of claim 1, wherein the composite material is applied by molding the material around the pipe.

10. The method of claim 1, wherein the composite material is applied by extruding the material.

11. The method of claim 1, wherein the composite material is applied by spraying the material.

12. The method of claim 1, wherein the composite material is applied with a release layer.

13. The method of claim 1, wherein the composite material is applied through extrusion.

14. The method of claim 1, further including the step of using rollers to maintain a uniform thickness of the composite material.

15. The method of claim 1, wherein the composite material exhibits a cladding density between 2200 kg/m³and 4000 kg/m³.

16. The method of claim 1, further including the step of adding or integrating a housing along the pipe for optical sensing equipment to monitor leakage or failure of pipe structure.

17. The method of claim 1, further including the steps of:
providing a plurality of pipe sections;
coating each section with the fiber-reinforced brittle matrix composite material; and
assembling the sections into a pipeline.

18. A pipeline constructed in accordance with the method of claim 15.

19. The method of claim 2, further including the steps of:
providing a plurality of pipe sections;
coating each section with the fiber-reinforced brittle matrix composite material; and
assembling the sections into a pipeline.

20. A pipeline constructed in accordance with the method of claim 17.
